(19) United States
(12) Patent Application Publication
(10) Pub. No.: US 2015/0225989 A1
(43) Pub. Date: Aug. 13, 2015

(54) PORTABLE LOCK-DOWN SYSTEM

(71) Applicants: Celisa Jeanette Edwards, Pendergrass, GA (US); Curtis Lee Edwards, Pendergrass, GA (US)

(72) Inventors: Celisa Jeanette Edwards, Pendergrass, GA (US); Curtis Lee Edwards, Pendergrass, GA (US)

(21) Appl. No.: 14/696,095

(22) Filed: Apr. 24, 2015

Related U.S. Application Data
(63) Continuation-in-part of application No. 14/161,599, filed on Jan. 22, 2014.

(51) Int. Cl. E05C 19/18

(52) U.S. Cl. CPC E05C 19/184

(57) ABSTRACT

A portable lock down device having at least one end encircling or grasping a door or window handle or other fixed object on the door, a cable or other flexible material extending to a loop or cable attachment device allowing easy attachment and detachment to the primary fixed eyebolt via a spring coupling device, the lock-down system passing through an eyebolt or collapsible ring adjacent to the door's edge, coupling to a primary eyebolt mounted in the wall and out of reach of an intruder so as to provide classroom security.

### CROSS-REFERENCE TO RELATED APPLICATIONS

This application is a Continuation-In-Part of U.S. Non-provisional patent application Ser. No. 14/161,599, filed Jan. 22, 2014, currently pending, which claims the benefit of U.S. provisional application 61/755,059 filed Jan. 22, 2013 and is herein incorporated by reference in their entirety.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

1. Field of Invention

The present disclosure relates generally to safety locking mechanism. More specifically, the present disclosure relates to a security mechanism to prevent the exit or entrance through a door or window or the like.

2. Description of Prior Art

Unfortunately, we live in a world today in which it is all too common to see violent acts committed against students in a school setting. Sadly, many of these violent acts have resulted in school children being killed or severely injured by intruders armed with knives or guns. Often times, the only defense these students and teachers have is to lock or barricade the door and hope that the intruder cannot enter the room. Therefore, in these tragic situations, the locking mechanism of the door or window may determine life or death.

The conventional “Adjustable Chain Door” encompasses the use of a slide bracket that is anchored to the door and a second bracket that is anchored to an adjacent wall, such that a chain may be detachably coupled to the slide bracket through a coupling element. While these designs provide some protection to the user, they have several short comings.

In a school environment these devices fail in varying ways. First the classroom doors have windows. Breaking the window will allow the intruder to unhook such devices. Second, because these devices are permanently attached, the devices may be engaged by student and intruders alike, locking out teachers and/or administrators. Third, engaging supplemental locking devices can be slow and/or cumbersome.

Therefore, a need exists for a security mechanism that is affordable, easily and quickly attachable by the user, and not easily accessible by an intruder. The present disclosure addressed these needs.

### SUMMARY OF THE INVENTION

Briefly described, the present disclosure overcomes the above-mentioned disadvantages and meets a recognized need for such an apparatus by providing a portable lock down device comprising, in some embodiments, a cable having a first end and a second end where the first end is removably attached to a door or window handle or the like, the cable being threaded through a first wall fastener and the second end having a means for removable attaching to a second wall fastener, thereby causing the cable to be taught when the cable is attached to the second wall fastener, and the second wall fastener being positioned such that it is unreachable from the door or window, preventing the door or window from being opened.

In other embodiments, the first end and the second end each terminate in a loop.

In other embodiments, the means for removably attaching the second end to the second wall fastener is a spring loaded coupling device. In some embodiments, the spring loaded coupling device is a carabineer.

In other embodiments, the first and second wall fasteners can be an eye bolt, crank eyed bolt or ring bolt.

In some embodiments, the first and second wall fasteners are positioned substantially parallel to the door or window handle, or can also be offset from one another.

In further embodiments, the cable is made of steel or stainless steel and may comprise wire rope.

In other embodiments, the first wall fastener is positioned such that it cannot be reached from the door or window. The first and second wall fasteners may also be positioned such that the first wall fastener is a first distance from the door or window and the second wall fastener is twice the first distance from the door or window.

The present disclosure also provides for a method of securing a door or window by applying the portable lockdown system to the door or window, thus preventing an unwanted intruder from opening the door or window and gaining entrance into the room.

As is presently described the portable lock down system can be used to secure a door window or the like in virtually any setting such as a home, business or school classroom. The present disclosure, therefore, provides some advantages that include, but are not limited to when mounted on an in swinging door, the cable passes through a secondary eyebolt, close to the doors edge, limiting its swing, while coupling to a primary eyebolt out of an intruders reach.

Another feature of the present portable lock down device is, in the event of a breach in the classroom door's window, an intruder cannot uncouple the spring-loaded devices; it cannot be manipulated and is out of reach.

Another feature of the present portable lock down device is the cable is slightly flexible limiting the impact of a sudden force applied to the door.

Another feature of the present portable lock down device is the relatively ease of installation and minimal cost, as opposed to waiting for the approval of retooling all the school locks and still having the window breach problem.

Yet another advantage of the present portable lock-down device is the prevention of the need for a teacher to barricade the doors in the case of a lockdown, which in practice is cumbersome and risk injury from weighty objects, such is impractical for drills as well. While this action might slow down the intruder with an in-swinging door, it is virtually useless in an out swinging door application that is designed in many schools.

Still another advantage of the present portable lock-down device is the relief felt by the teacher and the students during a school intrusion, any amount of stress relief in these situations is gratifying.

These and other exemplary features and advantages of the present invention will become clear from the following description with reference to the accompanying drawings.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a front view of an embodiment of a portable carrying device with the lock down cable enclosed.

FIG. 2 is a class room door assembly showing a breached window, an in swinging door, and an embodiment of a portable lock down device mounting system.

FIG. 3 is an enlarged perspective view showing the embodiment of a portable lock down system of FIG. 2 in the secured state.

FIG. 4 is a top perspective view of an embodiment of a portable lock down system preventing a door from being opened.

FIG. 5 is a perspective view of an embodiment of a portable lock downs system in use with an out swinging door.

FIG. 6 is a top perspective view of an embodiment of a portable lock down system preventing an out swinging door from opening.

### DETAILED DESCRIPTION OF THE INVENTION

The present disclosure relates to security devices that can be used to secure a door, window or the like that open to the outside or inside. In particular, the portable lock down device and method of use described here can be used, in some instances, to secure a classroom door from being open by an intruder.

Reference is made herein to the attached drawings. For the purposes of presenting a brief and clear description of the present invention, the preferred embodiment will be discussed as used for entrance and exit security. The figures are intended for representative purposes only and should not be considered to be limiting in any respect.

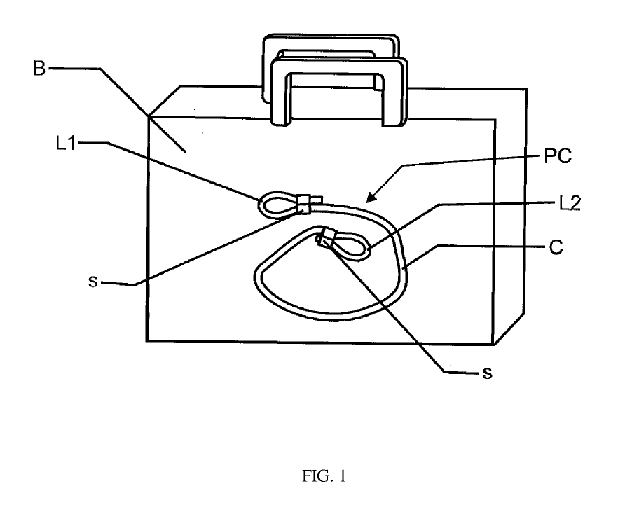

Referring now to FIG. 1-6, there is shown an exemplary embodiment(s) of a portable lock down system of the present disclosure, which generally comprises a portable component and a permanent or semi-permanent component. The transportable component generally comprises at least one flexible cable, chain, wire or the like preferably having a high tensile and sheer strength capable of withstanding repeated attempts to prevent a door or window from being broken into by a determined attacker.

The permanent or semi-permanent component generally consists of at least two fasteners that are used to anchor the cable to the wall where one end of the cable is removably attached to a door or window handle and the other end is removable attached to a first fastener where the cable is treaded through a second fastener located there between. The fasteners are, in some embodiments, an eye bolt, ring bolt, crank eyed bolt or a similar device, or a combination thereof.

Referring now to FIG. 1 there is depicted an embodiment of the portable component according to the present disclosure that is transportable and available for quick deployment when needed. As shown in FIG. 1, the portable lock down system is transportable by brief case B, and comprises Portable cable PC, having a cable C, with first loop L1, formed an secured by a fastener S, with a second loop L2 formed in a similar fashion. The portable lock down system is flexible and compact enough to fit into a number of transport containers such as small bags, boxes, or as shown above for example, in a small brief case. This also makes the portable component easy to store when no longer needed.

The flexible cable, chain, wire or similar device is preferably made of a metal such as steel, stainless steel or another metal alloy. Furthermore, the cable or the like may include natural or synthetic fibers such as hemp, linen, cotton, coir, jute, straw, sisal, polypropylene, nylon, polyesters (e.g. polyethylene terephthalate, liquid crystal polymer, high density polyethylene, Vectran), polyethylene (e.g. Dyneem and Spectra), Aramids (e.g. Twaron, Technora and Kevlar) and acrylics (e.g. Dralon) or a combination thereof. The cable is preferably of the wire rope variety that may include stranded, spiral or strand rope, but may also include other types of cables as well.

The flexible cable, chain, wire or similar device is preferably adapted to fit any door or window handle or similar protrusion where the loop can be removably attached to the window or door. The cable is preferably about 6″-12″, about 6″-24″, about 6″-36″, or about 6″-48″. In other embodiments, the cable length is about 27″-28″.

The flexible cable, chain, wire or similar device preferably has a loop or lariat at one end, and preferably a loop at each end. The loops can be created through the application of a fastener to one end of the cable, for example, such that the fastener creates an open loop. The fastener is preferably made of a metal or metal alloy material. In some embodiments, the fastener is a piece of metal or metal alloy material that is crimped onto the cable to form the loop. In other embodiments, the fasteners are made of steel or stainless steel. In other embodiments, the fasteners are thimbles, wire rope clamps or clips, swaged, wedge sockets, potted or poured sockets or eye splices.

In other embodiments, one of the cable loops is sized such that it can it easily slide over any common door knob or handle, or over any window opening device. In other embodiments, one of the loop ends, preferably the loop end that is opposite of the loop end that is engaged to a door handle or knob, is sized to fit a coupling device. The coupling device will allow the cable to be easily attached to a wall fastener device anchored to a wall or other surface. The loop may also be sized such that it can be treaded through various wall fasteners, such as an eye bolt.

The coupling device is preferably a spring loaded coupling device that allows easy attachment to a wall fastener. The coupling device forms a bridge between the cable loop and wall fastener. The spring loaded coupling device gives a secure attachment while simultaneously requiring manual removal by the user. This positive engagement to the wall fastener eliminates the possibility of accidental detachment from the wall fastener. It would also require an intruder to positively actuate the spring loaded coupling device, which, when appropriately place, becomes virtually impossible to accomplish. In some embodiments, the spring loaded coupling device is a carabineer type fastener. In further embodiments, the coupling device is another fastener such as a hook or clasp.

The cable preferably has one loop removably attached to the door or window knob/opener and the second loop threaded through a first fastener anchored into a wall and then removably attached to a second fastener anchored to a wall, through a coupling device, the coupling device being attached the second loop. The wall fasteners, which in some embodiments are eye bolts, are arranged to be substantially parallel to the door or window knob. In other embodiments, the wall fasteners are offset. In other embodiments, the wall fasteners are positioned offset such that the cable, when taught, forms a “V” or inverted “V” shape (one wall fastener is substantially parallel to the door handle while the second is substantially offset). In further embodiments, the wall fasteners are positioned equidistant or substantially equidistant from each other. In other embodiments, a fastener is placed a distance X from door or window. The second wall fastener can be placed about 1X, 2X, 3X, 4X, 5X, 6X, 7X or 8X the distance away from the first fastener. In some embodiments, one wall fastener is located about 27″-28″ from the door or window, and the second wall fastener is located about 6″-10″ away from the door or window.

In still further embodiments, it may be advantageous to use at least 2, at least 3, at least 4 or at least 5 wall fasteners. In other embodiments, the wall fasteners are positioned by the user in the best geometry to secure a particular door or window. The portable lock down system is effective in preventing both in swinging doors and out swinging doors from being unwantedly opened. In particular, the portable lock down system can be effective in preventing out-swinging doors or windows from being unwantedly open. This is because an out-swinging door or window cannot easily barricaded, thus requiring another means for keeping the door secure from threats from outside the door or window.

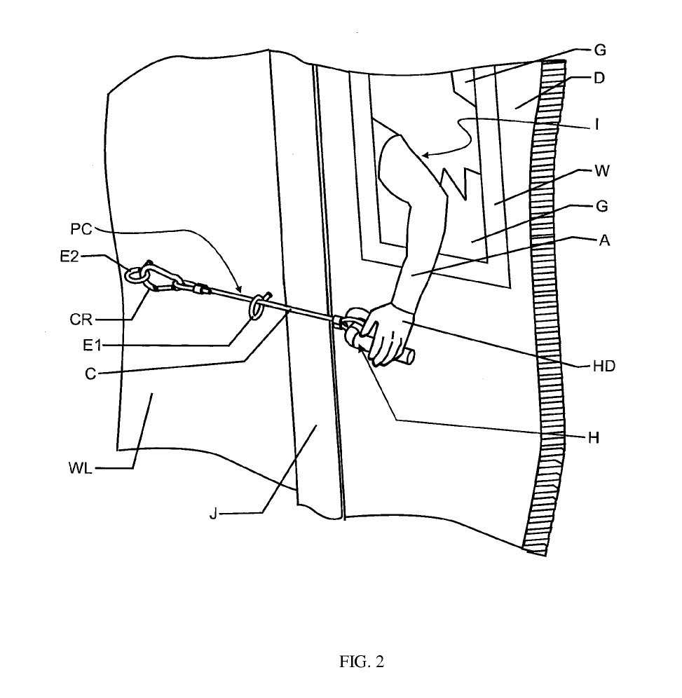

Referring now to FIG. 2, there is shown a classroom door assembly, comprising Door D, breached window W, Broken glass G, door handle H, with intruder I, consisting of arm A, and hand HD, trying to unlock handle H; wall WL, has door jam J, with closed door D, with door handle H, being unlocked by intruder I. An embodiment of the present disclosure is shown where a Portable cable assembly PC, prevents access by first loop or grasping device L1, encircling or grasping handle H, cable C, passing through fastener (such as an eye bolt or collapsing ring) E1, with second loop L2 attached to a spring loaded coupling device CR (e. g. a carabineer), which is attached to fastener eye bolt E2, well out of the reach of intruder I.

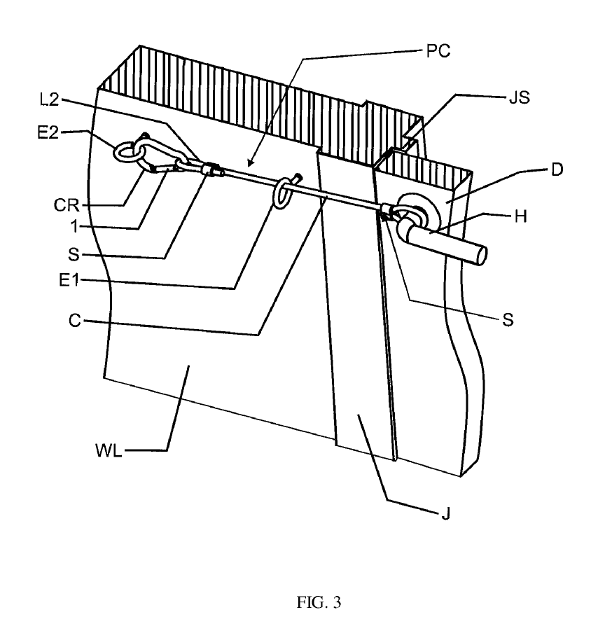

Referring now to FIG. 3 is an enlarged cutaway perspective view shown in FIG. 2 with door D, in the closed state; jam J, has a protruding edge JS, that acts as a stop for the in swinging door D, held snuggly into jam J, by door strike k. In this position, first end L1, formed by a fastener S, of portable cable assembly PC, loops over handle H, extended cable C, has second end L2, held taught by spring loaded coupling device CR attached to fastener eye bolt E2.

Moreover, fastener eye bolt E2, spring loaded coupling device CR, come in an endless variety of types, shapes, sizes and purposes, preferably said fasting device is not limited, cable C, includes other suitable characteristics, in an endless variety of types, such as durability, water-resistance, light weight, malleable, oxidation resistance, ease of workability, or other beneficial characteristic understood by one skilled in the art.

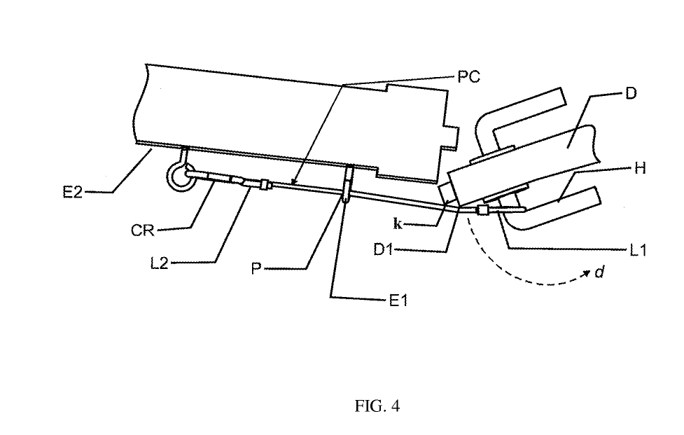

Referring now to FIG. 4 is an enlarged perspective top view shown in FIG. 3 with door D, held slightly ajar, Door D, is prevented from opening in direction d, because fastener eye bolt E1, is causing cable C, to bend at edge D1, fastener eye bolt E1, is within reach of intruder I, shown in FIG. 1.1, door D, is prevented from opening farther by Point P, on fastener eye bolt E1; loop L2, of portable cable assembly PC, is attached to fastener eye bolt E2, well out of reach of intruder I, shown in FIG. 2-3.

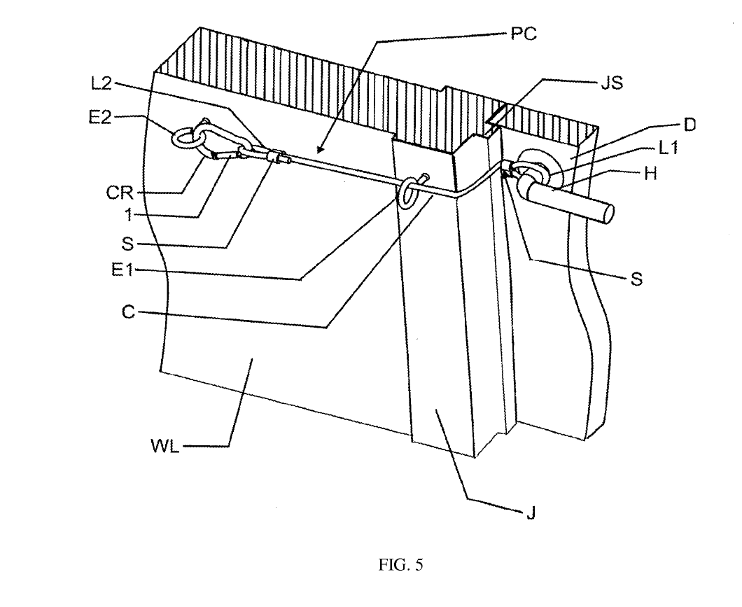

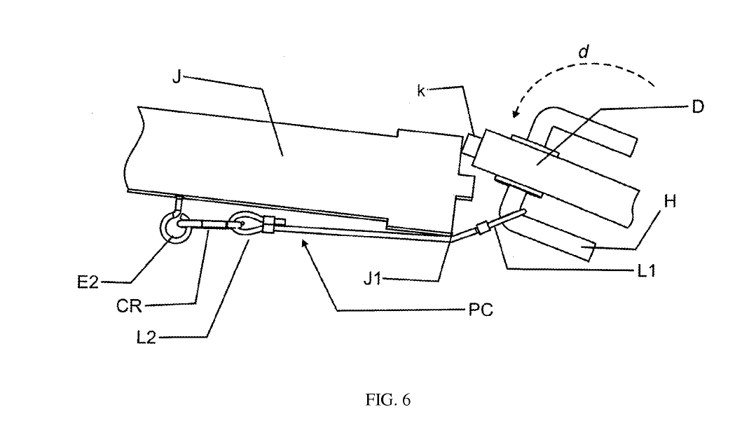

Referring now to FIG. 5 is a perspective view of an out swinging door in the closed state; jam J, has a protruding edge JS, that acts as a stop for out swinging door D, L1 encircles H handle with cable C passing through fastener E1 (optional eyehook or collapsible ring for out swinging doors) with L2 attached to fastener E2 with a spring loaded coupling device CR. Thus preventing door opening as shown in FIG. 6, indicated by motion d, door D, is prevented from opening by in this position cable first Loop L1, of portable cable assembly PC, and is held taught by second loop L2, encircling spring loaded coupling device CR, said spring loaded coupling device (for example, a carabineer) CR encircles fastener eye bolt E2, door D cannot open regardless of release by door strike k.

In other embodiments, it may be desirable to have the cable permanently located in close proximity to the door such as in a box or lock box. When needed, the cable, having at least a portion of cable accessible when positioned in the box, can be withdrawn from the box, threaded through a wall fastener and attached to the door or window. In other situations, the cable is retractable. In some embodiments, the box can be mounted on the door or window. In still further embodiments, the box can have a lock such as a manual key lock or electronic lock accessible through an electronic key or card or similar device.

Thus, a novel portable lock down system has been shown and described. Various changes and substitutions can of course be made without departing from the spirit and scope of the invention.

### DEFINITIONS

The following definitions are included to provide a clear and consistent understanding of the specification and claims. As used herein, the recited terms have the following meanings. All other terms and phrases used in this specification have their ordinary meanings as one of skill in the art would understand.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrase “one or more” is readily understood by one of skill in the art, particularly when read in context of its usage.

As used herein, the term “about” refers to an approximately +/−10% variation from a given value. It is to be understood that such a variation is always included in any given value provided herein, whether or not it is specifically referred to.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

What is claimed is:

1. A portable lock down device for a door or window comprising:
a cable having a first end and a second end, wherein the first end is removably attached to a door or window handle, the cable being threaded through a first wall fastener and the second end having a means for removably attaching to a second wall fastener, thereby causing the cable to be taught when the cable is attached to the second wall fastener, and the second wall fastener being positioned such that it is unreachable from the door or window, thereby preventing the door or window from being opened.

2. The portable lock down device of claim 1 wherein the first end terminates in a loop and the second end terminates in a loop.

3. The portable lock down device of claim 1 wherein the means for removably attaching the second end to the second wall fastener is a spring loaded coupling device.

4. The portable lock down device of claim 3 wherein the spring loaded coupling device is a carabineer.

5. The portable lock down device of claim 1 wherein the first and second wall fasteners are selected from the group consisting of an eye bolt, crank eyed bolt or ring bolt.

6. The portable lock down device of claim 5 wherein the first and second wall fasteners are eye bolts.

7. The portable lock down device of claim 1 wherein the first and second wall fasteners are positioned substantially parallel to the door or window handle.

8. The portable lock down device of claim 1 wherein the first and second wall fasteners are offset from each other.

9. The portable lock down device of claim 1 wherein the cable is made of steel.

10. The portable lock down device of claim 1 wherein the cable comprises wire rope.

11. The portable lock down device of claim 1 wherein the door is an out-swinging door or an in-swinging door.

12. The portable lock down device of claim 1 wherein the first wall fastener is positioned such that it cannot be reached from the door or window.

13. The portable lock down device of claim 1 wherein the first wall fastener is a first distance from the door or window and the second wall fastener is twice the first distance from the door or window.

14. A method for securing a door or widow comprising applying the portable lock down device of claim 1 to a door or window.
